(19) United States
(12) Patent Application Publication
(10) Pub. No.: US 2024/0320533 A1
(43) Pub. Date: Sep. 26, 2024

(54) APPARATUS, METHOD, AND COMPUTER PROGRAM FOR ALLOWING AN AUTHENTICATOR TO AUTHENTICATE A SUPPLICANT

(71) Applicant: Nokia Technologies Oy, Espoo (FI)

(72) Inventor: Danny DE VLEESCHAUWER, Antwerp (BE)

(21) Appl. No.: 18/601,902

(22) Filed: Mar. 11, 2024

(30) Foreign Application Priority Data
Mar. 23, 2023 (GB) 2304259.1

(51) Int. Cl. G06N 10/20

(52) U.S. Cl. CPC G06N 10/20

(57) ABSTRACT

The disclosure relates to an apparatus configured to: generate (600) M qubits |c [symbol] based on a challenge c; transform (602) the M qubits |c [symbol] into M qubits |x [symbol] using at least an M qubit phase shifting gate Λₐ known to the apparatus and unknown to a supplicant; transmit (604), to the supplicant, the M qubits |x [symbol] ; receive (606), from the supplicant, M qubits |x′ [symbol] ; transform (608) the M qubits |x′ [symbol] into M qubits |c′ [symbol] using at least an inverse M qubits phase shifting gate Λₛ^{†} and using an inverse M qubits phase shifting gate Λₐ⁵⁵⁴; and authenticate (610) the supplicant based on measuring the M qubits |c′ [symbol] and comparing the measurement of the M qubits |c′ [symbol] to the challenge c.

### FIELD OF THE DISCLOSURE

The present disclosure relates to an apparatus, a method, and a computer program for allowing an authenticator to authenticate a supplicant.

### BACKGROUND

The term authentication may be used in different contexts: data authentication and identity authentication.

In identity authentication, a supplicant (a user or a device) may need to prove his/her/its identity to an authenticator in order to get access to a network, a compute infrastructure, a bank account, a building, etc. For that purpose, the parties perform an interactive protocol in which the supplicant proves possession of some unique data, (i.e., the supplicant shows that he/she/it knows some shared secret or possesses some token or has some specific attribute).

One or more aspect of this disclosure relate to identity authentication.

### SUMMARY

According to an aspect there is provided an apparatus comprising at least one processor and at least one memory storing instructions that, when executed by the at least one processor, cause the apparatus at least to: generate M qubits |c [symbol] based on a challenge c; transform the M qubits |c [symbol] into M qubits |x [symbol] using at least an M qubit phase shifting gate Λₐ known to the apparatus and unknown to a supplicant; transmit, to the supplicant, the M qubits |x [symbol] ; receive, from the supplicant, M qubits |x′ [symbol] ; transform the M qubits |x′ [symbol] into M qubits |c′ [symbol] using at least an inverse M qubits phase shifting gate Λₛ^{†} and using an inverse M qubits phase shifting gate Λₐ^{†}; and authenticate the supplicant based on measuring the M qubits |c′ [symbol] and comparing the measurement of the M qubits |c′ [symbol] to the challenge c.

M may be an integer greater than or equal to one.

The supplicant may be another apparatus.

The M qubits |x [symbol] may be transformed by the supplicant into M qubits |x′ [symbol] using an M qubits phase shifting gate Λₛ known to the apparatus and known to the supplicant.

Transforming the M qubits |c [symbol] into M qubits |x [symbol] may comprise spreading the M qubits |c [symbol] into M qubits |x [symbol] and rotating the M qubits |x [symbol] .

Transforming the M qubits |x′ [symbol] into M qubits |c′ [symbol] may comprise rotating the M qubits |x′ [symbol] and dispreading the M qubits |x′ [symbol] into M qubits |c′ [symbol] .

The M qubits |c [symbol] may comprise a basis state |00 . . . , 0 [symbol] , |00 . . . 1 [symbol] , . . . |11 . . . 1 [symbol] of a standard M qubits rectilinear basis.

The basis state may correspond to a challenge c∈{0, 1, . . . , 2^{M}−1} randomly selected by the apparatus.

The apparatus may comprise at least one processor and at least one memory storing instructions that, when executed by the at least one processor, cause the apparatus at least to: transmit, to the supplicant, the M qubits Ix) in parallel.

The apparatus may comprise at least one processor and at least one memory storing instructions that, when executed by the at least one processor, cause the apparatus at least to: transform the M qubits |c [symbol] into the M qubits |x [symbol] using an M qubits Fourier gate [symbol] _{M}; and transform the M qubits |x′ [symbol] into the M qubits |c′ [symbol] using an inverse M qubits Fourier gate [symbol] _{M}⁵⁵⁴.

The M qubits Fourier gate [symbol] _{M} operates according to a (2^{M}×2^{M}) matrix of the following form:

$$〈 m \vert {ℱ}_{M} \vert {m}^{′} 〉 = \frac{1}{\sqrt{{2}^{M}}} {ω}_{M}^{m m ′}$$

$$wherein {ω}_{M} = exp ( \frac{i 2 π}{{2}^{M}} ) .$$

The M qubits phase shifting gate Λₐ may be configured with M phases to shift the M qubits.

The M phases may be different.

The M qubits phase shifting gate Λₐ may comprise an oracle G constructed based on a classical function g.

The oracle G may map |m,n [symbol] to |m, (n+g(m))mod N [symbol] with |m,n [symbol] referring to a product state |m [symbol] ⊗|n [symbol] and ⊗ referring to an outer product.

N may be an integer greater than or equal to one.

The oracle G may be fed M qubits Fourier transformed M qubits |c [symbol] and N qubits Fourier transformed N qubits |a′ [symbol] , wherein the N qubits |a′ [symbol] comprises a basis state known to the apparatus and unknown to the supplicant.

The M qubit phase shifting gate Λₛ^{†} may comprises an oracle F^{†} constructed based on a classical function −ƒ mod 2^{N} and wherein the M qubit phase shifting gate Λₛ^{†} may comprise an oracle G^{†} constructed based on a classical function −g mod 2^{N}.

Authenticating the supplicant based on measuring the M qubits |c′ [symbol] and comparing the measurement of the M qubits |c′ [symbol] to the challenge c may comprise: measuring the M qubits |c′ [symbol] ; determining that the measurement of the M qubits |c′ [symbol] matches the challenge c; and authenticating the supplicant.

According to an aspect there is provided an apparatus comprising means for: generating M qubits |c [symbol] based on a challenge c; transforming the M qubits |c [symbol] into M qubits |x [symbol] using at least an M qubit phase shifting gate Λₐ known to the apparatus and unknown to a supplicant; transmitting, to the supplicant, the M qubits |x [symbol] ; receiving, from the supplicant, M qubits |x′ [symbol] ; transforming the M qubits |x′ [symbol] into M qubits |c′ [symbol] using at least an inverse M qubits phase shifting gate Λₛ^{†} and using an inverse M qubits phase shifting gate Λₐ^{†}; and authenticating the supplicant based on measuring the M qubits |c′ [symbol] and comparing the measurement of the M qubits |c′ [symbol] to the challenge c.

According to an aspect there is provided an apparatus comprising circuitry configured to: generate M qubits |c [symbol] based on a challenge c; transform the M qubits |c [symbol] into M qubits |x [symbol] using at least an M qubit phase shifting gate Λₐ known to the apparatus and unknown to a supplicant; transmit, to the supplicant, the M qubits |x [symbol] ; receive, from the supplicant, M qubits |x′ [symbol] ; transform the M qubits |x′ [symbol] into M qubits |c′ [symbol] using at least an inverse M qubits phase shifting gate Λₛ^{†} and using an inverse M qubits phase shifting gate Λₐ^{†}; and authenticate the supplicant based on measuring the M qubits |c′ [symbol] and comparing the measurement of the M qubits |c′ [symbol] to the challenge c.

According to an aspect there is provided a method comprising: generating M qubits |c [symbol] based on a challenge c; transforming the M qubits |c [symbol] into M qubits |x [symbol] using at least an M qubit phase shifting gate Λₐ known to an apparatus and unknown to a supplicant; transmitting, to the supplicant, the M qubits |x [symbol] ; receiving, from the supplicant, M qubits |x′ [symbol] ; transforming the M qubits |x′ [symbol] into M qubits |c′ [symbol] using at least an inverse M qubits phase shifting gate Λₛ^{†} and using an inverse M qubits phase shifting gate Λₐ^{†}; and authenticating the supplicant based on measuring the M qubits |c′ [symbol] and comparing the measurement of the M qubits |c′ [symbol] to the challenge c

According to an aspect there is provided a computer program comprising computer executable code which when run on at least one processor is configured to: generate M qubits |c [symbol] based on a challenge c; transform the M qubits |c [symbol] into M qubits |x [symbol] using at least an M qubit phase shifting gate Λₐ known to an apparatus and unknown to a supplicant; transmit, to the supplicant, the M qubits |x [symbol] ; receive, from the supplicant, M qubits |x′ [symbol] ; transform the M qubits |x′ [symbol] into M qubits |c′ [symbol] using at least an inverse M qubits phase shifting gate Λₛ^{†} and using an inverse M qubits phase shifting gate Λₐ^{†}; and authenticate the supplicant based on measuring the M qubits |c′ [symbol] and comparing the measurement of the M qubits |c′ [symbol] to the challenge c.

According to an aspect there is provided an apparatus comprising at least one processor and at least one memory including computer code for one or more programs, the at least one memory and the computer code configured, with the at least one processor, to cause the apparatus at least to: receive, from an authenticator, M qubits |x [symbol] ; transform the M qubits |x [symbol] into M qubits |x′ [symbol] using an M qubits phase shifting gate Λₛ known to the apparatus and known to the authenticator; and transmit, to the authenticator, the M qubits |x′ [symbol] .

Transforming the M qubits |x [symbol] into M qubits |x′ [symbol] may comprise rotating the M qubits |x [symbol] .

The M qubits phase shifting gate Λₛ may be configured with M phases to shift the M qubits.

The M phases may be different.

The M qubits phase shifting gate Λₛ may comprise an oracle F constructed based on a classical function ƒ.

The oracle F may map |m,n [symbol] to |m, (n+ƒ(m))mod N), with |m,n [symbol] referring to the product state |m [symbol] |⊗|n [symbol] and ⊗ referring to the outer product.

The oracle F may be fed the M qubits |x [symbol] and N qubits Fourier transformed N qubits |a [symbol] , wherein the N qubits |a [symbol] comprises a basis state known to the apparatus and known to the authenticator.

According to an aspect there is provided an apparatus comprising means for: receiving, from an authenticator, M qubits |x [symbol] ; transforming the M qubits |x [symbol] into M qubits |x′ [symbol] using an M qubits phase shifting gate Λₛ known to the apparatus and known to the authenticator; and transmitting, to the authenticator, the M qubits |x′ [symbol] .

According to an aspect there is provided an apparatus comprising circuitry configured to: receive, from an authenticator, M qubits |x [symbol] ; transform the M qubits |x [symbol] into M qubits |x′ [symbol] using an M qubits phase shifting gate Λ_{S} known to the apparatus and known to the authenticator; and transmit, to the authenticator, the M qubits |x′ [symbol] .

According to an aspect there is provided a method comprising: receiving, from an authenticator, M qubits |x [symbol] ; transforming the M qubits |x [symbol] into M qubits |x′ [symbol] using an M qubits phase shifting gate Λ_{S} known to an apparatus and known to the authenticator; and transmitting, to the authenticator, the M qubits |x′ [symbol] .

According to an aspect there is provided a computer program comprising computer executable code which when run on at least one processor is configured to: receive, from an authenticator, M qubits |x [symbol] ; transform the M qubits |x [symbol] into M qubits |x′ [symbol] using an M qubits phase shifting gate Λ_{S} known to an apparatus and known to the authenticator; and transmit, to the authenticator, the M qubits |x′ [symbol] .

According to an aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### BRIEF DESCRIPTION OF THE FIGURES

Embodiments will now be described, by way of example only, with reference to the accompanying Figures in which:

FIG. 1 shows a schematic representation of a user equipment, wherein the user equipment may be an authenticator or a supplicant;

FIG. 2 shows a schematic representation of a process for allowing an authenticator to authenticate a supplicant;

FIG. 3 shows complex probability amplitudes [symbol] c′|c [symbol] plotted for 10000 random choices of phases (φ′ₘ−φₘ) for M=2, 4, 6 and 8;

FIG. 4 shows how a probability amplitude [symbol] c′|c [symbol] of a basis state |c′ [symbol] is a sum of 2^{M} complex terms;

FIG. 5a shows a schematic representation of a process for allowing an authenticator to authenticate a supplicant;

FIG. 5b shows a schematic representation of a process for selecting a rotor;

FIG. 5c shows a schematic representation of a three-way handshake process for allowing an authenticator to authenticate a supplicant and for allowing the supplicant to authenticate the authenticator.

FIG. 6 shows a block diagram of a method for allowing an authenticator to authenticate a supplicant performed by an apparatus (e.g. authenticator);

FIG. 7 shows a block diagram of a method for allowing an authenticator to authenticate a supplicant performed by an apparatus (e.g. supplicant); and

FIG. 8 shows a schematic representation of a non-volatile memory medium storing instructions which when executed by a processor allow a processor to perform one or more of the steps of the methods of FIGS. 7 and 8.

### DETAILED DESCRIPTION OF THE FIGURES

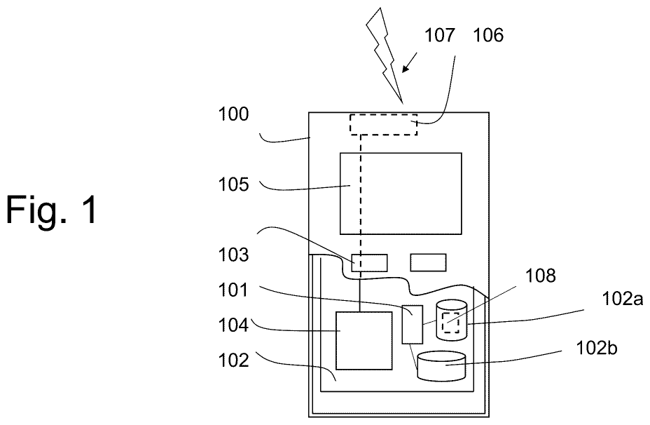

FIG. 1 illustrates an example of a UE 100. In the context of this disclosure, the UE 100 may be an authenticator or a supplicant. The UE 100 may be provided by any device capable of sending and receiving qubits.

The UE 100 may receive signals (carrying qubits) via appropriate transceiver apparatus and may transmit signals (carrying qubits) via appropriate apparatus. In FIG. 1 transceiver apparatus is designated schematically by block 106.

The UE 100 may be provided with at least one processor 101, at least one memory 102 (e.g. at least one ROM 102a and/or at least one RAM 102b) and other possible components 103 for use in software and hardware aided execution of tasks it is designed to perform, including control of access to and communications with access systems and other communication devices. The at least one processor 101 is coupled to the RAM 102b and the ROM 102a. The at least one processor 101 may be configured to execute an appropriate software code 108. The software code 108 may for example allow to perform one or more of the present aspects. The software code 108 may be stored in the ROM 102a.

The processor, storage and other relevant control apparatus can be provided on an appropriate circuit board and/or in chipsets. This feature is denoted by reference 104. The device may optionally have a user interface such as keypad 105, touch sensitive screen or pad, combinations thereof or the like. Optionally one or more of a display, a speaker and a microphone may be provided depending on the type of the device.

It will be understood that although the following concepts may be implemented by a UE, such as the UE of FIG. 1, one or more of these concepts may be applied to other apparatuses.

One or more aspect of this disclosure relate to identity authentication.

One or more aspect of this disclosure relates to a quantum solution wherein the secret information, which the supplicant needs to prove his/her/its identity, is hidden in the phases of the qubits that the supplicant and authenticator exchange.

In the following we first discuss the general principle with generic phase shifting gates and subsequently show how to construct such phase shifting gates based on classical functions.

In quantum computing a gate (also referred to as a quantum gate or quantum logic gate) is a basic quantum system operating on a small number of qubits. A gate may be represented by a matrix.

The quantum solution may rely on an M qubits phase shifting gate Λₐ only known to the authenticator (M may be an integer equal to or greater than one). A (2^{M}×2^{M}) matrix corresponding to the M qubits shifting gate Λₐ may be of form:

$${Λ}_{a} = diag ( exp ( i ϕ ) )$$

where i is the imaginary unit (i.e., i²−1) and ϕ=(ϕ₀, ϕ₁, . . . , ϕ₂_{^{M}}₋₁) is a vector with phases (ϕₘ∈[0, 2π)).

An inverse (i.e., Hermitian conjugate) M qubits shifting gate Λₐ^{†} may be of the form:

$${Λ}_{a} = diag ( exp ( - i ϕ ) ) .$$

The quantum solution may rely on an M qubits shifting gate Λₛ known to the supplicant and the authenticator as a shared secret. A (2^{M}×2^{M}) matrix corresponding to the M qubits shifting gate Λₛ may be of the form:

$${Λ}_{s} = diag ( exp ( i φ ) )$$

where i is the imaginary unit (i.e., i²−1) and φ=(φ₀, φ₁, . . . , φ₂_{^{M}}₋₁) is a vector with phases (φₘ∈[0, 2π)) known to the supplicant and authenticator as a shared secret.

An inverse (i.e., Hermitian conjugate) M qubits shifting gate Λₛ^{†} may be of the form:

$${Λ}_{s} = d i a g ( exp ( - i ϕ ) ) .$$

The quantum solution may rely on an M qubits Fourier gate [symbol] _{M}. A (2^{M}×2^{M}) matrix corresponding to the M qubits Fourier gate [symbol] F_{M} may be of the form

$$〈 m \vert {ℱ}_{M} \vert {m}^{′} 〉 = \frac{1}{\sqrt{{2}^{M}}} {ω}_{M}^{m m ′}$$

$$where {ω}_{M} = exp ( \frac{i 2 π}{{2}^{M}} ) .$$

An inverse (i.e., Hermitian conjugate) M qubits Fourier gate [symbol] _{M}^{†} may be of the form:

$$〈 m \vert {ℱ}_{M}^{†} \vert {m}^{′} 〉 = \frac{1}{\sqrt{{2}^{M}}} {ω}_{M}^{- m {m}^{′}}$$

The skilled person would know how to construct such M qubits Fourier gate [symbol] _{M} and therefore more details are not provided in this respect.

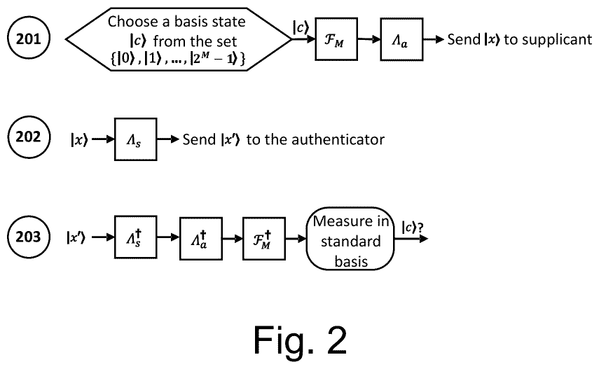

FIG. 2 shows a schematic representation of a process for allowing an authenticator to authenticate a supplicant. FIG. 2 shows one authentication cycle.

In step 201, the authenticator may randomly select a challenge c∈{0, 1, . . . , 2^{M-1}} (only known to the authenticator). The challenge c may be a bitstring 00 . . . 0, 00 . . . 1, . . . , 11 . . . 1. The challenge c may correspond to a basis state |00 . . . 0 [symbol] , |00 . . . 1 [symbol] , . . . |11 . . . 1 [symbol] (i.e., all possible bit strings of length M) of a standard M qubits rectilinear basis. The authenticator may generate M qubits |c [symbol] comprising the basis state.

More specifically, a challenge c 00 . . . 0 may correspond to the basis state |00 . . . 0 [symbol] , a challenge c 00 . . . 1 may correspond to the basis state |00 . . . 1 [symbol] , a challenge c 11 . . . 1 may correspond to a basis state |11 . . . 1 [symbol] , etc.

|0 [symbol] , |1 [symbol] }. M|00 . . . 0 [symbol] , |00 . . . 1 [symbol] , . . . , |11 . . . 1 [symbol] Ml|l [symbol] is 0 00 . . . 0, 1 00 . . . 1, 2^{M}−1 11 . . . 1012^{M}−1 MM It will be understood that the rectilinear basis for one qubit is a set {Here, we are using a rectilinear basis for qubits, which is a set { } (i.e., all bitstrings of length). The label inside the ket just a name. In the description, the following shorthand notations may be used:

|0 [symbol] , |1 [symbol] }. M|00 . . . 0 [symbol] , |00 . . . 1 [symbol] , . . . , |11 . . . 1 [symbol] Ml|l [symbol] is 0 00 . . . 0, 1 00 . . . 1, 2^{M}−1 11 . . . 1012^{M}−1MM integer for bitstring integer for bitstring . . . integer for bitstring. So, each choice of an integer, . . . , corresponds to one bitstring of bits, and hence, to one of the basis vectors of the rectilinear basis for qubits.

The authenticator may transform the M qubits |c [symbol] into M qubits |x [symbol] using an M qubits Fourier gate [symbol] _{M} and an M qubits phase shifting gate Λₐ (only known to the authenticator).

The authenticator may transmit the M qubits |x [symbol] to the supplicant. For example, the authenticator may transmit the M qubits |x [symbol] to the supplicant in parallel.

In step 202, the supplicant may transform the M qubits |x [symbol] into M qubits |x′ [symbol] using an M qubits phase shifting gate Λₛ (known to the authenticator and the supplicant as a shared secret).

The supplicant may transmit the M qubits |x′ [symbol] to the authenticator. For example, the supplicant may transmit the M qubits |x′ [symbol] to the authenticator in parallel.

In step 203, the authenticator may transform the M qubits |x′ [symbol] into the M qubits |c′ [symbol] using an inverse M qubits phase shifting gate Λₛ^{†}, an inverse M qubits phase shifting gate Λₐ^{†} and an inverse M qubits Fourier gate [symbol] _{M}^{†}. The M qubits |x′ [symbol] may be input to the inverse M qubits phase shifting gate Λₛ^{†}. The output of the inverse M qubits phase shifting gate Λₛ^{†} may be input to the inverse M qubits phase shifting gate Λₐ^{†}. The output of the inverse M qubits phase shifting gate Λₐ^{†} may be input to and the inverse M qubits Fourier gate [symbol] _{M}^{†}. The output of the inverse M qubits Fourier gate [symbol] _{M}^{†} may be the M qubits |c′ [symbol] .

The authenticator may measure the M qubits |c′ [symbol] . The result of measuring the M qubits |c′ [symbol] may be a bitstring. For example, the authenticator may measure the M qubits |c′ [symbol] in the standard M qubits rectilinear basis. The authenticator may compare the measured bitstring to the challenge c. If the measured bitstring matches the challenge c, the authenticator may authenticate the supplicant. If the measured bitstring does not match the challenge c, the authenticator may not authenticate the supplicant.

It will be understood that although FIG. 2 represents a process with a single authentication cycle, other processes may use multiple authentication cycles.

The probability that the authenticator measures the bitstring to be equal to the challenge c is the square | [symbol] c′|c [symbol] |² of the probability amplitude of the M qubits |c′ [symbol] , which is given by:

$$〈 {c}^{′} \vert c 〉 = \frac{1}{{2}^{M}} {\sum }_{m = 0}^{{2}^{M} - 1} exp ( i ( {φ}_{m}^{′} - {φ}_{m} ) ) {ω}_{M}^{m ( c - {c}^{′} )}$$

where φ′ denotes that a malicious UE trying to impersonate the supplicant might have used a guess φ′ for the actual phases φ. Since the supplicant knows the actual phases (φ′=φ), the probability that the authenticator measures the bitstring matching the challenge c would be 1. Remark that if the phase shifts that the supplicant and authenticator would differ by a constant (φ′ₘ−φₘ=constant independent of m), the probability of the authenticator measuring the bitstring matching the challenge c would also be 1. Hence, two M qubits phase shifting gate Λₛ that differ by a constant may be considered to be equivalent.

If a malicious user tries to impersonate the supplicant by intercepting the M qubits |x [symbol] and using a guessed set of phases φ′, the phase differences φ′ₘ−φₘ in the above sum composing the probability amplitude [symbol] c′|c [symbol] may be considered to be random.

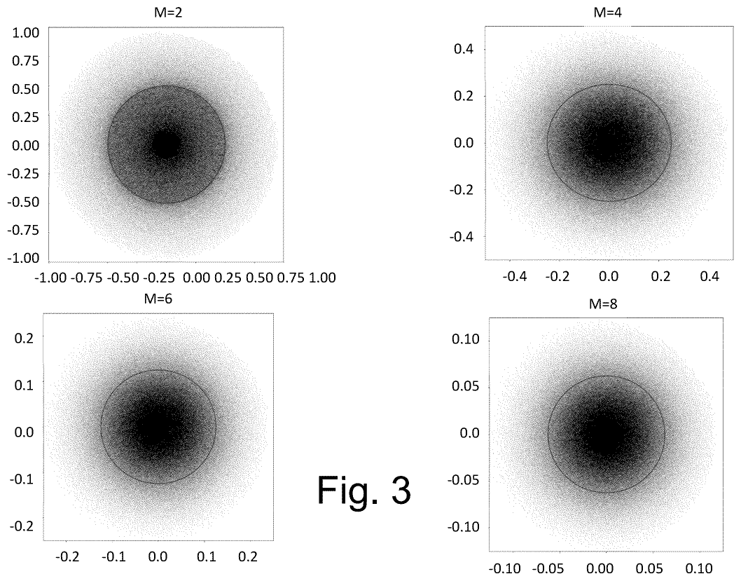

FIG. 3 shows the complex probability amplitude [symbol] c′|c [symbol] plotted for 10000 random choices of the phases ((φ′ₘ−φₘ) for M=2, 4, 6 and 8. The probability that the bitstring is obtained by measuring the M qubits |c′ [symbol] is the square | [symbol] c′|c [symbol] |² of the length of this probability amplitude. Note that this probability amplitude is smaller than 2^{-M} (where the circle lines indicate the loci of length 2^{-M}) for most random choices of these phases.

In this Fig. the phase differences are independent, identically distributed random variables that are uniformly distributed in the interval [0, 2π). Note that applying the Fourier transform to the phase difference term (i.e., the factor ω_{M}^{m(c-c′)} in each term of the above sum for [symbol] c′|c [symbol] ), does not alter the statistics of the phase differences: after Fourier transform the phase differences are still independent identically distributed with uniform distribution. Hence, the probability that the authenticator will obtain the bitstring by measuring the M qubits |c′ [symbol] is very close to 2^{-2M} for all values of the M qubits |c′ [symbol] .

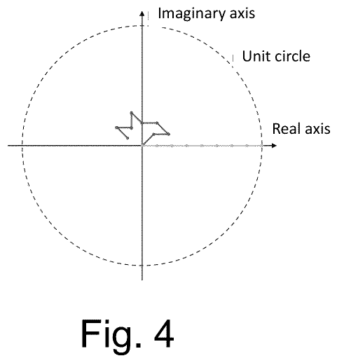

FIG. 4 illustrates this graphically: the only case in which the 2^{M} terms in the sum composing the probability amplitude [symbol] c′|c [symbol] constructively interfere is where φ′ₘ−φₘ=constant. In all other cases, for all intents and purposes, they destructively interfere when a malicious UE impersonates the supplicant.

The probability amplitude [symbol] c′|c [symbol] of the M qubits |c′ [symbol] is a sum of 2^{M} complex terms. A first line (starting from the centre continuing within the unit circle over the Real axis) shows how the 2^{M} terms in the sum constructively interfere under normal operation. A second line (starting from the centre and continuing within the unit circle) shows how the 2^{M} terms in the sum destructively interfere when a malicious UE tries to impersonate the supplicant.

If a malicious UE tries to impersonate the authenticator, using the same procedure as the authenticator, but his/her/its own choice of M qubits phase shifting gate Λₐ=I (where I is the identity operator), with a similar reasoning as above, the probability that the malicious UE measures the bitstring is the square | [symbol] c′|c [symbol] |² of the probability amplitude of |c′ [symbol] , which is:

$$〈 {c}^{′} \vert c 〉 = \frac{1}{{2}^{M}} {\sum }_{m = 0}^{{2}^{M} - 1} exp ( i {φ}_{m} ) {ω}_{M}^{m ( c - {c}^{′} )}$$

where φ=(φ₀, φ₁, . . . , φ₂^{M}₋₁) are the secret phases that the supplicant uses.

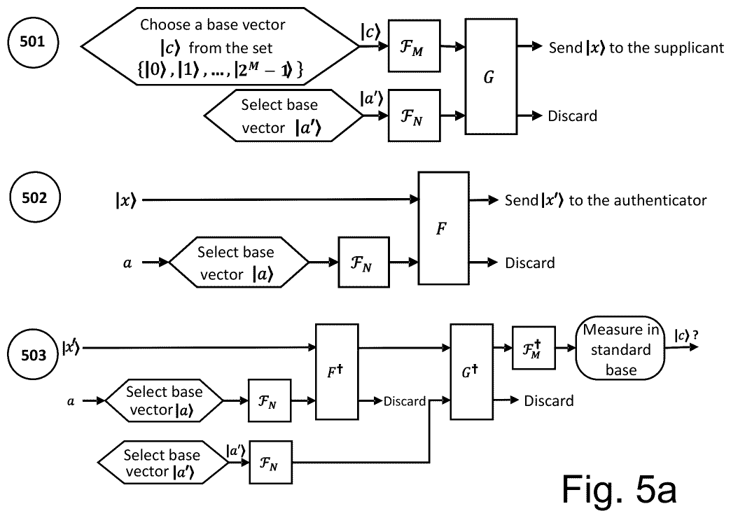

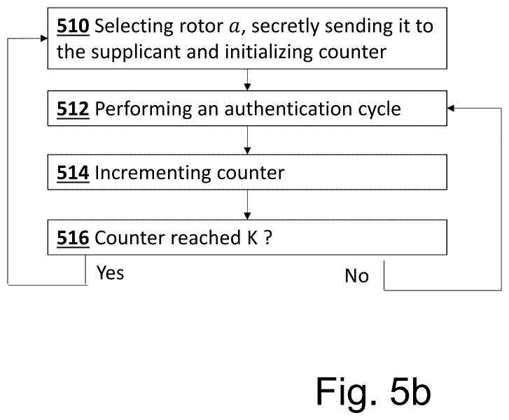

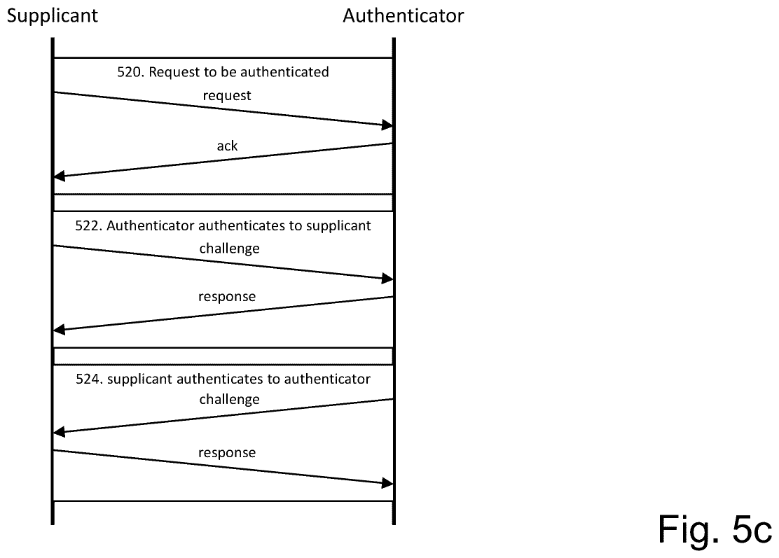

By probing the supplicant many times (i.e., a multiple of (2^{M})² times), these probabilities could be approximately measured. In that way, the malicious UE may get some information pertaining to these phases that the supplicant uses. However, it is very unlikely that these probabilities can be measured accurately enough before the supplicant and authenticator detect that there is some tampering going on. Note that the no cloning theorem prevent the attacked to reuse the same qubits twice. Moreover, this problem can be circumvented, if the authenticator needs to authenticate him/her/itself to the supplicant before he/she/it can ask the supplicant to authenticate. In that way the authentication becomes a three-way handshake. An example of a three-way handshake process will be described further in this disclosure in reference to FIG. 5c.

A malicious UE could measure the M qubits |x [symbol] being sent from authenticator and supplicant or from supplicant to authenticator, in any basis (e.g., in the standard rectilinear basis or in the Fourier basis (which is equivalent to applying a Fourier gate before measuring)). Since the M qubits phase shifting gate Λₐ (only known to the authenticator) is potentially changed for every authentication cycle, the malicious UE has no way of gaining information with respect to the secret that the authenticator and supplicant share. Measuring collapses the state to any of the basis states of the measuring basis, and, in particular, destroys the phase information. As a result a malicious UE performing a measurement essentially boils down to interrupting the channel between authenticator and supplicant, which will easily be noticed.

In the above general M qubits phase shifting gates have been used. However, M qubits phase shifting gates can be constructed based on a classical function. Consider the classical function:

$$f : \{ 0 , 1 , … , {2}^{M} - 1 \} \to \{ 0 , 1 … , {2}^{N} - 1 \} \\ m \to f ( m )$$

There are 2^{N2}^{^{M}} such functions. Although functions that differ by an additional constant may essentially be equivalent, each supplicant may be provided with a unique function, if M and N are chosen large enough.

The classical function ƒ may be implemented as a quantum circuit F. In particular, the quantum circuit may map a basis state |m, n [symbol] to a basis state |m, (n+ƒ(m))mod N [symbol] . Here |m,n [symbol] is short-hand notation for a product state |m [symbol] ⊗|n [symbol] with ⊗ the outer product (also referred to as Kronecker product).

In the prior art such a circuit F is often referred to as an “oracle”. The skilled person would know (e.g., from the theory of reversible computing) how to construct such an oracle F from a classical function ƒ. The oracle F, as any quantum gate, may also take a superposition of basis states as input. The eigenstates of the oracle F are:

$$\vert m 〉 ⊗ {ℱ}_{N} \vert n 〉$$

with corresponding eigenvalues

$${ω}_{N}^{- nf ( m )} \\ for m = 0 , 1 , … , {2}^{M} - 1 and n = 0 , 1 , … , {2}^{N} - 1.$$

Consider the superposition of basis states:

$${\sum }_{m = 0}^{M - 1} {α}_{m} \vert m 〉$$

For any choice of a (a parameter referred to as the “rotor” for reasons that will become clear later), feeding the oracle F with the product state of this state with the state obtained by feeding the basis state corresponding to rotor a through a Fourier gate, i.e.,

$${\sum }_{m = 0}^{M - 1} {α}_{m} \vert m 〉 ⊗ {ℱ}_{N} \vert a 〉$$

yields

$${\sum }_{m = 0}^{M - 1} {α}_{m} {ω}_{N}^{- af ( m )} \vert m 〉 ⊗ {ℱ}_{N} \vert a 〉$$

It may be noted that the second factor (i.e., [symbol] _{N}|a [symbol] ) in the product state was not altered in this process. Discarding this second factor yields the desired phase shifting operator, namely a diagonal unitary operator Λ with phases

$${φ}_{m} = - 2 π \frac{af ( m )}{{2}^{N}}$$

Note that in the generic system described above two sets of phases may be equivalent if they differ by a constant. Similarly, two functions that differ by a constant mod 2_{N} may also be equivalent.

The rotor a may be any positive number. The rotor a may amplify the phases: a large value of a rotates each term in the sum proportionally more (hence, the name for this parameter a). Different values for a just yield different ways in which the terms in the sum can destructively interfere. Changing the rotor a after a number of authentication cycles may yield a stronger guarantee of security.

An example is now provided with M=3 and N=2. For the example the matrices corresponding to the quantum operators can still be explicitly written down. This example is detailed for illustrative purposes only. In practice M and N may be chosen larger. In theory, M and N may be chosen smaller and may even be equal to one.

First notice that

$${ω}_{N} = {ω}_{2} = exp ( \frac{i π}{2} ) = i .$$

The following classical function ƒ may be selected:

| m | 000 | 001 | 010 | 011 | 100 | 101 | 110 | 111 |
|---|---|---|---|---|---|---|---|---|
| ƒ(m) | 01 | 11 | 00 | 10 | 11 | 01 | 10 | 10 |

Here m and n are represented in their binary notation to emphasize that they will be encoded in qubits by contrast to above where we represented them as integers for conciseness of notation.

The matrix associated to the oracle F implementing ƒ is (where the bold 0 denotes the 4×4 zero matrix):

$$F = ( \begin{matrix}\begin{matrix}0 & 0 & 0 & 1 \\ 1 & 0 & 0 & 0 \\ 0 & 1 & 0 & 0 \\ 0 & 0 & 1 & 0\end{matrix} & 0 & 0 & 0 & 0 & 0 & 0 & 0 \\ 0 & \begin{matrix}0 & 1 & 0 & 0 \\ 0 & 0 & 1 & 0 \\ 0 & 0 & 0 & 1 \\ 1 & 0 & 0 & 0\end{matrix} & 0 & 0 & 0 & 0 & 0 & 0 \\ 0 & 0 & \begin{matrix}1 & 0 & 0 & 0 \\ 0 & 1 & 0 & 0 \\ 0 & 0 & 1 & 0 \\ 0 & 0 & 0 & 1\end{matrix} & 0 & 0 & 0 & 0 & 0 \\ 0 & 0 & 0 & \begin{matrix}0 & 0 & 1 & 0 \\ 0 & 0 & 0 & 1 \\ 1 & 0 & 0 & 0 \\ 0 & 1 & 0 & 0\end{matrix} & 0 & 0 & 0 & 0 \\ 0 & 0 & 0 & 0 & \begin{matrix}0 & 1 & 0 & 0 \\ 0 & 0 & 1 & 0 \\ 0 & 0 & 0 & 0 \\ 1 & 0 & 0 & 1\end{matrix} & 0 & 0 & 0 \\ 0 & 0 & 0 & 0 & 0 & \begin{matrix}0 & 0 & 0 & 1 \\ 1 & 0 & 0 & 0 \\ 0 & 1 & 0 & 0 \\ 0 & 0 & 1 & 0\end{matrix} & 0 & 0 \\ 0 & 0 & 0 & 0 & 0 & 0 & \begin{matrix}0 & 0 & 1 & 0 \\ 0 & 0 & 0 & 1 \\ 1 & 0 & 0 & 0 \\ 0 & 1 & 0 & 0\end{matrix} & 0 \\ 0 & 0 & 0 & 0 & 0 & 0 & 0 & \begin{matrix}0 & 0 & 1 & 0 \\ 0 & 0 & 0 & 1 \\ 1 & 0 & 0 & 0 \\ 0 & 1 & 0 & 0\end{matrix}\end{matrix} )$$

This matrix is unitary as it has only one 1 in each row and column. Hence, this matrix is implementable as a quantum circuit. The block structure may be noted. However, since each block is (potentially) different, there may not be a tensor product (or Kronecker product) of two matrices of lower rank.

As an example, we choose as rotor a=01. It can easily be checked that any state

$$\vert m 〉 ⊗ \frac{1}{2} ( \vert 00 〉 + i \vert 01 〉 - \vert 10 〉 - i \vert 11 〉 ) = \frac{1}{2} \vert m , 00 〉 + \frac{i}{2} \vert m , 01 〉 - \frac{1}{2} \vert m , 10 〉 - \frac{i}{2} \vert m , 11 〉$$

with m=000, 001, . . . , 111 is an eigenstate with eigenvalue i^{-ƒ(m)}, by applying oracle F to any of these states and grouping the right terms.

Consider the superposition of basis states:

$${α}_{000} \vert 000 〉 + {α}_{001} \vert 001 〉 + … + {α}_{111} \vert 111 〉$$

The product state of this state with the state obtained by feeding the basis state |a [symbol] corresponding to the rotor a=01, through a Fourier gate is:

$$( {α}_{000} \vert 000 〉 + {α}_{001} \vert 001 〉 + … + {α}_{111} \vert 111 〉 ) ⊗ ( \frac{1}{2} ( \vert 00 〉 + i \vert 01 〉 - \vert 10 〉 - i \vert 11 〉 ) ) =$$

$$\frac{{α}_{000}}{2} \vert 000 , 00 〉 + \frac{{α}_{001}}{2} \vert 001 , 00 〉 + … + \frac{{α}_{111}}{2} \vert 111 , 00 〉 + \frac{i {α}_{000}}{2} \vert 000 , 01 〉 +$$

$$\frac{i {α}_{001}}{2} \vert 001 , 01 〉 + … + \frac{i {α}_{111}}{2} \vert 111 , 01 〉 - \frac{{α}_{000}}{2} \vert 000 , 10 〉 - \frac{{α}_{001}}{2} \vert 001 , 10 〉 - … -$$

$$\frac{{α}_{111}}{2} \vert 111 , 10 〉 - \frac{i {α}_{000}}{2} \vert 000 , 11 〉 - \frac{i {α}_{001}}{2} \vert 001 , 11 〉 + … - \frac{i {α}_{111}}{2} \vert 111 , 11 〉$$

Applying the oracle F to this quantum state (grouping the correct terms to form eigenvectors) and discarding the two least significant bits, yields:

$${i}^{- f ( 000 )} {α}_{000} \vert 000 〉 + {i}^{- f ( 001 )} {α}_{001} \vert 001 〉 + … + {i}^{- f ( 111 )} {α}_{111} \vert 111 〉$$

as desired.

The authenticator and the supplicant may use the same rotor a in each specific authentication cycle. However, the rotor a may differ from authentication cycle to authentication cycle. They can agree upfront to use a certain value (or a list of values that are valid at different times) or they can rely on a classical or quantum key distribution protocol to agree upon a word of N bits. We assume that this may be done prior to the authentication cycle.

FIG. 5a shows a schematic representation of a process for allowing an authenticator to authenticate a supplicant. FIG. 5a shows one authentication cycle.

In step 501, the authenticator may randomly select a challenge c∈{0, 1, . . . , 2^{M}−1} (only known to the authenticator). The challenge c may correspond to a basis state |00 . . . 0 [symbol] , 00 . . . 1) [symbol] . . . |11 . . . 1 [symbol] (i.e., all possible bit strings of length M) of a standard M-qubits rectilinear basis. The authenticator may generate M qubits |c [symbol] comprising the basis state.

The authenticator may select a rotor a′ (only known to the authenticator). The rotor a′ may correspond to a basis state |00 . . . 0 [symbol] , |00 . . . 1 [symbol] , . . . |11 . . . 1 [symbol] (i.e., all possible bit strings of length N) of a standard N qubits rectilinear basis. The authenticator may generate N qubits |a′ [symbol] comprising the basis state.

The authenticator may transform the M qubits |c [symbol] and the N qubits |a′ [symbol] into M qubits |x [symbol] using an M qubits Fourier gate [symbol] _{M}, an N qubits Fourier gate [symbol] _{N} and an oracle G. More specifically, the M qubits |c [symbol] may be input to the M qubits Fourier gate [symbol] _{M}. The N qubits |a′ [symbol] may be input to the N qubits Fourier gate [symbol] _{N}. The output of the M qubits Fourier gate [symbol] _{M} and the output of the N qubits Fourier gate [symbol] _{N}, concatenated together in that order, may be input to the oracle G. The first M qubits of the output of the oracle G may be the M qubits |x [symbol] .

The authenticator may transmit the M qubits |x [symbol] to the supplicant. For example, the authenticator may transmit the M qubits |x [symbol] to the supplicant in parallel.

In step 502, the supplicant may select a rotor a known to the authenticator and the supplicant as a shared secret. The rotor a may correspond to a basis state |00 . . . 0 [symbol] , |00 . . . 1 [symbol] , . . . |11 . . . 1 [symbol] (i.e., all possible bit strings of length N) of a standard N qubits rectilinear basis. The supplicant may generate a N qubits |a [symbol] comprising the basis state.

The supplicant may transform the M qubits |x [symbol] and the N qubits |a [symbol] into M qubits |x′ [symbol] using an N qubits Fourier gate [symbol] _{N} and an oracle F. More specifically, the N qubits |a [symbol] may be input to the N qubits Fourier gate [symbol] _{N}. The M qubits |x [symbol] and the output of the N qubits Fourier gate [symbol] _{N}, concatenated together in that order, may be input to the oracle F. The first M qubits of the output of the oracle F may be the M qubits |x′ [symbol] .

The supplicant may transmit the M qubits |x′ [symbol] to the authenticator. For example, the supplicant may transmit the M qubits |x′ [symbol] to the authenticator in parallel.

In step 503, the authenticator may select the same rotor a known to the authenticator and the supplicant as shared secret, that the supplicant used in step 502.

The authenticator may transform the M qubits |x′ [symbol] into M qubits |c′ [symbol] using two N qubits Fourier gates [symbol] _{N}, an inverse oracle F^{†}, an inverse oracle G^{†} and an inverse M qubits Fourier gate [symbol] _{M}^{†}. More specifically, the N qubits |a [symbol] may be input to a first N qubits Fourier gate [symbol] _{N}. The N qubits |a′ [symbol] may be input to a second N qubits Fourier gate [symbol] F_{N}. The M qubits |x′ [symbol] and the output of the first N qubits Fourier gate [symbol] _{N}, concatenated together in that order, may be input to the inverse oracle F^{†}. The first M qubits of the output of the inverse oracle F^{†} and the output of the second N qubits Fourier gate [symbol] _{N}, concatenated in that order, may be input to the inverse oracle G^{†}. The first M qubits of the output of the inverse oracle G^{†} may be input to the inverse M qubits Fourier gate [symbol] _{M}^{†}. The output of the inverse M qubits Fourier gate [symbol] _{M}^{†} may be the M qubits |c′ [symbol] .

The authenticator may measure the M qubits |c′ [symbol] . The result of measuring the M qubits |c′ [symbol] may be a bitstring. For example, the authenticator may measure the M qubits |c′ [symbol] in the standard M qubits rectilinear basis. The authenticator may compare the measured bitstring to the challenge c. If the measured bitstring matches the challenge c, the authenticator may authenticate the supplicant. If the measured bitstring does not match the challenge c, the authenticator may not authenticate the supplicant.

FIG. 5b shows a schematic representation of a process for selecting rotor a.

It will be understood that the rotor a (chosen by the authenticator) may be hardcoded in the supplicant's software (and kept secret). In a similar way, the function ƒ (also chosen by the authenticator) may be hardcoded in the supplicant's software (and kept secret). In that case the rotor a (as the function ƒ) may be static (i.e. it never changes). Alternatively, the rotor a may be dynamic if there is a secret way to share the rotor a between the supplicant and the authenticator.

In step 510, the authenticator may select the rotor a. The authenticator may secretly share the rotor a with the supplicant by using a same classical or quantum key distribution protocol.

The authenticator may select the rotor a′. The authenticator may not share the rotor a′ with the supplicant.

The authenticator may initialize a counter to 0. Alternatively, the authenticator may initialize a counter to K.

In step 512, the authenticator and the supplicant may perform an authentication cycle. For example, the authenticator and the supplicant may perform the process of FIG. 5a.

In step 514, the authenticator may increment the counter. Alternatively, the authenticator may decrement the counter.

In step 516, the authenticator may determine if the counter reached K. Alternatively, the authenticator may determine if the counter reached 0.

If the counter reaches K or alternatively the counter reaches 0, the process loops back to step 510. If the counter does not reach K or alternatively the counter does not reach 0, the process loops back to step 512.

It will be understood that the M qubits phase shifting gate Λₐ (only known the [symbol] authenticator) applied to the M qubit |c [symbol] is implemented via a secret classical function g (only known to the authenticator) implemented in the oracle G which is fed by an M qubits Fourier transformed challenge M qubits |c [symbol] and an N qubits Fourier transformed N qubits |a′ [symbol] (only known to the authenticator).

The M qubits phase shifting gate Λ_{S} (which is a shared secret between the supplicant and authenticator) is implemented via a secret classical function ƒ (known to the authenticator and the supplicant) implemented in the oracle F. The oracle F is fed by the M qubits |x [symbol] and an N qubits Fourier transformed N qubits |a [symbol] . The N qubits |a [symbol] may correspond to the rotor a that the authenticator secretly may secretly share with the supplicant or using a classical or quantum key distribution protocol triggered by the method explained in step 510 of FIG. 5b.

The Hermitian conjugates of the oracles Ft and Gf are implemented based on the classical function −ƒ mod 2_{N} and −g mod 2_{N} respectively.

The probability that an authentication succeeds by chance is of the order 2^{-2M}. To increase the reliability of the system, either M needs to be chosen larger or authentication needs to run through multiple authentication cycles.

It will be understood that the above quantum solution may rely on the authenticator sending a challenge c encoded in M qubits in parallel and the supplicant replying with M qubits in parallel. Both these messages may be transported over open communication channels. Also, both parties may rely on a rotor a encoded in N classical bits which either needs to be agreed upon upfront or for which they rely on a classical or quantum key distribution protocol.

FIG. 5c shows a schematic representation of a three-way handshake process for allowing an authenticator to authenticate a supplicant and for allowing the supplicant to authenticate the authenticator. In step 520 the supplicant may express the wish to be authenticated to the authenticator. In step 522 the authenticator may rely on the techniques disclosed in this disclosure to authenticate his-/her-/itself towards the supplicant by responding to a challenge the supplicant sends. In that way, the authenticator may prove to the supplicant that he/she/it (i.e., the authenticator) is genuine and not an imposter. In step 524 (3) the authenticator may ask the supplicant to authenticate by responding to a challenge the authenticator sends to the supplicant. Note that step 520 and 522 could be combined.

It will be understood that although the above example uses multiple qubits, the same concept may be applied with single qubits.

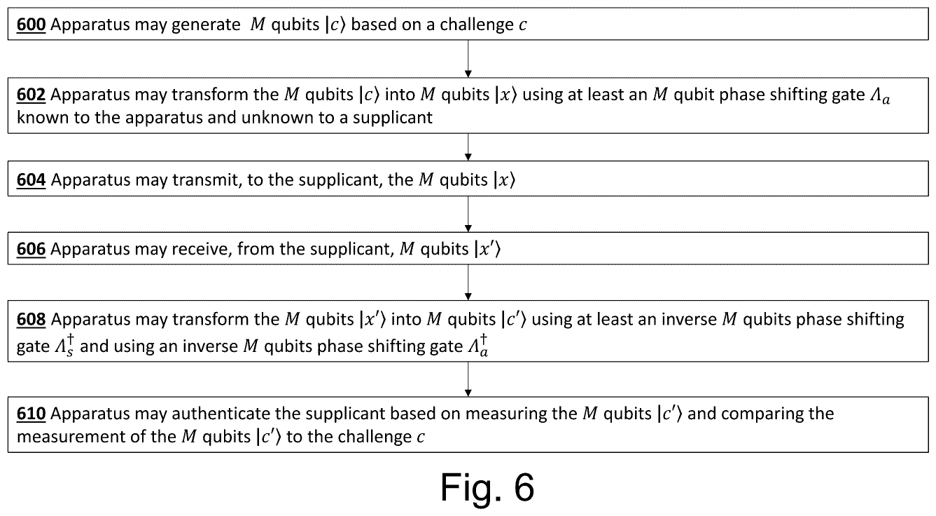

FIG. 6 shows a block diagram of a method for allowing an authenticator to authenticate a supplicant performed by an apparatus (e.g., authenticator).

In step 600, the apparatus may generate M qubits |c [symbol] based on a challenge c.

In step 602, the apparatus may transform the M qubits |c [symbol] into M qubits |x [symbol] using at least an M qubit phase shifting gate Λₐ known to the apparatus and unknown to a supplicant.

In step 604, the apparatus may transmit, to the supplicant, the M qubits |x [symbol] .

In step 606, the apparatus may receive, from the supplicant, M qubits |x′ [symbol] .

In step 608, the apparatus may transform the M qubits |x′ [symbol] into M qubits |c′ [symbol] using at least an inverse M qubits phase shifting gate Λₛ^{†} and using an inverse M qubits phase shifting gate Λₐ^{†}.

In step 6101, the apparatus may authenticate the supplicant based on measuring the M qubits |c′ [symbol] and comparing the measurement of the M qubits |c′ [symbol] to the challenge c.

M may be an integer greater than or equal to one.

The supplicant may be another apparatus.

The M qubits |x [symbol] may be transformed by the supplicant into M qubits |x′ [symbol] using an M qubits phase shifting gate Λₛ known to the apparatus and known to the supplicant.

Transforming the M qubits |c [symbol] into M qubits |x [symbol] may comprise spreading the M qubits |c [symbol] into M qubits |x [symbol] and rotating the M qubits |x [symbol] .

Transforming the M qubits |x′ [symbol] into M qubits |c′ [symbol] may comprise rotating the M qubits |x′ [symbol] and dispreading the M qubits |x′ [symbol] into M qubits |c′ [symbol] .

The M qubits |c [symbol] may comprise a basis state |00 . . . 0 [symbol] , |00 . . . 1 [symbol] , . . . , |11 . . . 1 [symbol] of a standard M qubits rectilinear basis.

The basis state may correspond to a challenge c∈{0, 1, . . . , 2^{M}−1} randomly selected by the apparatus.

The apparatus may transmit, to the supplicant, the M qubits |x [symbol] in parallel.

The apparatus may transform the M qubits |c [symbol] into the M qubits |x [symbol] using an M qubits Fourier gate [symbol] _{M}. The apparatus may transform the M qubits |x′ [symbol] into the M qubits |c′ [symbol] using an inverse M qubits Fourier gate [symbol] _{M}^{†}.

The M qubits Fourier gate [symbol] _{M} may operate according to a (2^{M}×2^{M}) matrix of the following form:

$$〈 m \vert {ℱ}_{M} \vert {m}^{′} 〉 = \frac{1}{\sqrt{{2}^{M}}} {ω}_{M}^{mm ′} \\ wherein {ω}_{M} = exp ( \frac{i 2 π}{{2}^{M}} ) .$$

The M qubits phase shifting gate Λₐ may be configured with M phases to shift the M qubits.

The M phases may be different.

The M qubits phase shifting gate Λₐ may comprises an oracle G constructed based on a classical function g.

The oracle G may map |m,n [symbol] to |m,(n+g(m))mod N) with |m,n [symbol] referring to a product state |m [symbol] ⊗|n [symbol] and ⊗ referring to an outer product.

N may be an integer greater than or equal to one.

The oracle G may be fed M qubits Fourier transformed M qubits |c [symbol] and N qubits Fourier transformed N qubits |a′ [symbol] , wherein the N qubits |a′ [symbol] comprises a basis state known to the apparatus and unknown to the supplicant.

The M qubit phase shifting gate Λₛ^{†} may comprise an oracle F^{†} constructed based on a classical function −ƒ mod 2_{N}. The M qubit phase shifting gate Λₐ^{†} may comprise an oracle G^{†} constructed based on a classical function −g mod 2_{N}.

Authenticating the supplicant based on measuring the M qubits |c′ [symbol] and comparing the measurement of the M qubits |c′ [symbol] to the challenge c may comprise: measuring the M qubits |c′ [symbol] ; determining that the measurement of the M qubits |c′ [symbol] matches the challenge c; and authenticating the supplicant.

Failing authenticating the supplicant based on measuring the M qubits |c′ [symbol] and comparing the measurement of the M qubits |c′ [symbol] to the challenge c may comprise: measuring the M qubits |c′ [symbol] ; determining that the measurement of the M qubits |c′ [symbol] does not match the challenge c; and authenticating the supplicant.

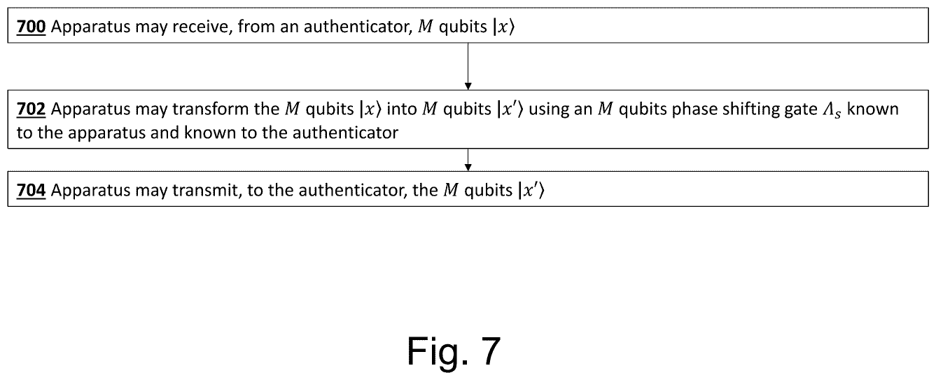

FIG. 7 shows a block diagram of a method for allowing an authenticator to authenticate a supplicant performed by an apparatus (e.g., supplicant).

In step 700, the apparatus may receive, from an authenticator, M qubits |x [symbol] .

In step 702, the apparatus may transform the M qubits |x [symbol] into M qubits |x′ [symbol] using an M qubits phase shifting gate Λₛ known to the apparatus and known to the authenticator.

In step 704, the apparatus may transmit, to the authenticator, the M qubits |x′ [symbol] .

Transforming the M qubits |x [symbol] into M qubits |x′ [symbol] may comprise rotating the M qubits |x [symbol] ].

The M qubits phase shifting gate Λₛ may be configured with M phases to shift the M qubits.

The M phases may be different.

The M qubits phase shifting gate Λ_{S} may comprise an oracle F constructed based on a classical function ƒ.

The oracle F may map |m,n [symbol] to |m,(n+ƒ(m))modN [symbol] , with |m,n [symbol] referring to the product state |m [symbol] ⊗|n [symbol] and ⊗ referring to the outer product.

The oracle F may be fed the M qubits |x [symbol] and N qubits Fourier transformed N qubits |a [symbol] , wherein the N qubits |a [symbol] comprises a basis state known to the apparatus and known to the authenticator.

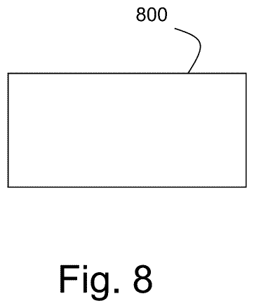

FIG. 8 shows a schematic representation of non-volatile memory media 800 storing instructions and/or parameters which when executed by a processor allow the processor to perform one or more of the steps of the methods of FIGS. 6 and 7.

It is noted that while the above describes example embodiments, there are several variations and modifications which may be made to the disclosed solution without departing from the scope of the present invention.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIGS. 6 and 7, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus comprising: at least one processor; and at least one memory storing instructions that, when executed by the at least one processor, cause the apparatus at least to:
generate M qubits |c [symbol] based on a challenge c;
transform the M qubits |c [symbol] into M qubits |x [symbol] using at least an M qubit phase shifting gate Λₐ known to the apparatus and unknown to a supplicant;
transmit, to the supplicant, the M qubits |x [symbol] ;
receive, from the supplicant, M qubits |x′ [symbol] ;
transform the M qubits |x′ [symbol] into M qubits |c′ [symbol] using at least an inverse M qubits phase shifting gate Λₛ^{†} and using an inverse M qubits phase shifting gate Λₐ^{†}; and
authenticate the supplicant based on measuring the M qubits |c′ [symbol] and compare the measurement of the M qubits |c′ [symbol] to the challenge c.

2. The apparatus of claim 1, wherein the M qubits |c [symbol] comprises a basis state |00 . . . 0 [symbol] , |00 . . . 1 [symbol] , . . . |11 . . . 1 [symbol] of a standard M qubits rectilinear basis.

3. The apparatus of claim 2, wherein the basis state corresponds to a challenge c∈{0, 1, . . . , 2^{M}−1} randomly selected by the apparatus.

4. The apparatus of claim 1, wherein the at least one processor; and the at least one memory storing instructions that, when executed by the at least one processor, further cause the apparatus at least to:
transmit, to the supplicant, the M qubits |x [symbol] in parallel.

5. The apparatus of claim 1, wherein the at least one processor; and the at least one memory storing instructions that, when executed by the at least one processor, further cause the apparatus at least to:
transform the M qubits |c [symbol] into the M qubits |x [symbol] using an M qubits Fourier gate [symbol] _{M}; and
transform the M qubits |x′ [symbol] into the M qubits |c′ [symbol] using an inverse M qubits Fourier gate [symbol] _{M}^{†}.

6. The apparatus of claim 5 wherein the M qubits Fourier gate [symbol] _{M} operates according to a (2^{M}×2^{M}) matrix of the following form:
$$〈 m \vert {ℱ}_{M} \vert {m}^{′} 〉 = \frac{1}{\sqrt{{2}^{M}}} {ω}_{M}^{mm ′} \\ wherein {ω}_{M} = exp ( \frac{i 2 π}{{2}^{M}} ) .$$

7. The apparatus of claim 1, wherein the M qubits phase shifting gate Λₐ is configured with M phases to shift the M qubits.

8. The apparatus of claim 7, wherein the M phases are different.

9. The apparatus of claim 1, wherein the M qubits phase shifting gate Λₐ comprises an oracle G constructed based on a classical function g.

10. The apparatus of claim 9, wherein the oracle G maps |m,n [symbol] to |m,(n+g(m))mod N [symbol] with |m,n [symbol] referring to a product state |m [symbol] ⊗|n [symbol] and ⊗ referring to an outer product.

11. The apparatus of claim 10, wherein the oracle G is fed M qubits Fourier transformed M qubits |c [symbol] and N qubits Fourier transformed N qubits |a′ [symbol] , wherein the N qubits |a′ [symbol] comprises a basis state known to the apparatus and unknown to the supplicant.

12. The apparatus of claim 1, wherein the M qubit phase shifting gate Λₛ^{†} comprises an oracle F^{†} constructed based on a classical function −ƒ mod 2_{N}; and
wherein the M qubit phase shifting gate Λₐ^{†} comprises an oracle Gt constructed based on a classical function −g mod 2_{N}.

13. The apparatus of claim 1, wherein the authenticating of the supplicant based on the measuring of the M qubits |c′ [symbol] and the comparing of the measurement of the M qubits |c′ [symbol] to the challenge c further comprises:
measure the M qubits |c′ [symbol] ;
determine that the measurement of the M qubits |c′ [symbol] matches the challenge c; and
authenticate the supplicant.

14. An apparatus comprising: at least one processor; and at least one memory storing instructions that, when executed by the at least one processor, cause the apparatus at least to:
receive, from an authenticator, M qubits |x [symbol] ;
transform the M qubits |x [symbol] into M qubits |x′ [symbol] using an M qubits phase shifting gate Λ_{S} known to the apparatus and known to the authenticator; and
transmit, to the authenticator, the M qubits |x′ [symbol] .

15. The apparatus of claim 14, wherein the M qubits phase shifting gate Λ_{S} is configured with M phases to shift the M qubits.

16. The apparatus of claim 15, wherein the M phases are different.

17. The apparatus of claim 14, wherein the M qubits phase shifting gate Λ_{S} comprises an oracle F constructed based on a classical function ƒ.

18. The apparatus of claim 17, wherein the oracle F maps |m,n [symbol] to |m, n+ƒ(m))mod N [symbol] , with |m,n [symbol] referring to the product state |m [symbol] ⊗|n [symbol] and ⊗ referring to the outer product.

19. The apparatus of claim 18, wherein the oracle F is fed the M qubits |x [symbol] and N qubits Fourier transformed N qubits |a [symbol] , wherein the N qubits |a [symbol] comprises a basis state known to the apparatus and known to the authenticator.

20. A method comprising:
generating M qubits |c [symbol] based on a challenge c;
transforming the M qubits |c [symbol] into M qubits |x [symbol] using at least an M qubit phase shifting gate Λₐ known to the apparatus and unknown to a supplicant;
transmitting, to the supplicant, the M qubits |x [symbol] ;
receiving, from the supplicant, M qubits |x′ [symbol] ;
transforming the M qubits |x′ [symbol] into M qubits |c′ [symbol] using at least an inverse M qubits phase shifting gate Λₛ^{†} and using an inverse M qubits phase shifting gate Λₐ^{†}; and
authenticating the supplicant based on measuring the M qubits |c′ [symbol] and comparing the measurement of the M qubits |c′ [symbol] to the challenge c.
